(19) United States
(12) Patent Application Publication
(10) Pub. No.: US 2009/0083326 A1
(43) Pub. Date: Mar. 26, 2009

(54) EXPERIENCE BOOKMARK FOR DYNAMICALLY GENERATED MULTIMEDIA CONTENT PLAYLIST

(76) Inventor: Gregory Dean PELTON, Raleigh, NC (US)

Correspondence Address: LEON R TURKEVICH, 2000 M STREET NW, 7TH FLOOR, WASHINGTON, DC, 200363307, US

(21) Appl. No.: 11/860,115

(22) Filed: Sep. 24, 2007

(51) Int. Cl. G06F 17/30

(52) U.S. Cl. 707/104.1; 707/E17.009

(57) ABSTRACT

In one embodiment, a method comprises identifying, by a multimedia generator circuit, media content elements from at least one available media source based on a prescribed multimedia presentation theme, each media content element identified as accessible from the at least one available media source via a corresponding media identifier, the prescribed multimedia presentation theme having been obtained by the multimedia generator circuit for a multimedia user; and automatically generating a playlist of multimedia content according to the multimedia presentation theme based on assembling the media identifiers according to a prescribed presentation preference.

### TECHNICAL FIELD

The present disclosure generally relates to storage and retrieval of “bookmarks” that identify locations of data structures (e.g., data files) or resources (e.g., web servers or web services), and generation of media playlists.

### BACKGROUND

Users of computers can manually create “bookmarks” to store links (e.g., uniform resource identifiers (URIs) or uniform resource locators (URLs)) to locate a web page for future reference. Users can maintain collections of bookmarks within web browsers executed by user devices. In addition, website services such as “My Yahoo” (available via the World Wide Web for example at the website address “my.yahoo.com”) and “iGoogle” (available via the World Wide Web at the website address “google.com/ig?hl=en”) offer personalized webpages that enable a user of the website service to store their bookmarks on their personalized webpage. Users also can publish their bookmarks for use by other users using social bookmarking services, available on the World Wide Web for example at the website address “del.icio.us”.

Playlists also can be manually created by users for a prescribed media type. For example, users can manually add music playlists to services such as “iTunes” or “Musicmatch Jukebox”, and video playlists can be manually added by users at video sites such as “YouTube” (available via the World Wide Web for example at the website address “youtube.com”). Certain service providers also can suggest a specific media file based on user preferences: for example, the online video rental service “Netflix” (available at the website address “netflix.com”) can offer video suggestions to subscribers based on subscriber selection history and subscriber ratings of previously-viewed videos; the website service at the website address “last.fm” uses a database that offers music suggestions based on tracking user listening habits, and calculating relationships and recommendations based on the user listening habits.

### BRIEF DESCRIPTION OF THE DRAWINGS

Reference is made to the attached drawings, wherein elements having the same reference numeral designations represent like elements throughout and wherein:

FIG. 1 illustrates an example system having an apparatus configured for automatically generating a playlist of multimedia content that defines a multimedia presentation, and a playlist identifier for distributed execution of the multimedia presentation, according to an example embodiment.

FIG. 2 illustrates an example method for automatically generating the playlist of multimedia content and the playlist identifier using the system of FIG. 1, according to an example embodiment.

FIG. 3 illustrates an example data structure illustrating a playlist of multimedia content, and example data structures illustrating respective playlist identifiers, according to example embodiments.

### DESCRIPTION OF EXAMPLE EMBODIMENTS OVERVIEW

In one embodiment, a method comprises identifying, by a multimedia generator circuit, media content elements from at least one available media source based on a prescribed multimedia presentation theme, each media content element identified as accessible from the at least one available media source via a corresponding media identifier, the prescribed multimedia presentation theme having been obtained by the multimedia generator circuit for a multimedia user; and automatically generating, by the multimedia generator circuit, a playlist of multimedia content according to the multimedia presentation theme based on assembling the media identifiers according to a prescribed presentation preference.

In another embodiment, an apparatus comprises a network interface circuit and a multimedia generator circuit. The network interface is configured for retrieving media identifiers from at least one available media source. The multimedia generator circuit is configured for identifying media content elements from the at least one available media source based on a prescribed multimedia presentation theme, each media identifier referencing the corresponding media content element from the at least one available media source, the prescribed multimedia presentation theme having been obtained by the multimedia generator circuit for a multimedia user. The multimedia generator circuit further is configured for automatically generating a playlist of multimedia content according to the multimedia presentation theme based on assembling the media identifiers according to a prescribed presentation preference.

### DETAILED DESCRIPTION

Particular embodiments create a new service based on a multimedia generator circuit (MGC) identifying media content elements having distinct media types and that are relevant to a prescribed multimedia presentation theme that is desired by a multimedia user. The term “multimedia presentation theme” refers to the overall subject matter or “theme” of the multimedia presentation that is presented to a consumer of the multimedia presentation (i.e., the multimedia user). The media content elements can include video files, audio files, image files, text files, etc. Each of the media content elements have subject matter attributes that can be expressed by a media tags associated with the respective media content elements. Subject matter attributes can include author of the media content element, user-assigned attributes related to the content, a time identifying the creation or last modification to the corresponding media content element, or a file name identifier. These subject matter attributes enable the media content elements to be categorized by the multimedia generator circuit according to the subject matter attributes which can include associated metadata, date/time, location, keywords, image analysis, size, etc. Hence, the media content elements can be identified by the multimedia generator circuit as relevant to a prescribed multimedia presentation theme based on a determined match (or relative correlation) between the multimedia presentation theme and the associated subject matter attributes.

The media content elements, reachable based on respective media identifiers (e.g., URIs, URLs, pathname or directory path within a local file system, etc.), can be assembled automatically by the multimedia generator circuit according to a prescribed multimedia presentation preference, enabling the multimedia generator circuit to form a playlist of multimedia content according to the multimedia presentation theme. Criteria used by the multimedia generator circuit for dynamically generating the playlist of multimedia content based on the prescribed multimedia presentation theme can include prescribed presentation preferences such as presentation duration, parental controls, and other user preference factors. As described above, the term “multimedia presentation theme” refers to the overall subject matter or “theme” of the multimedia presentation that is presented to a consumer of the multimedia presentation; hence, multimedia presentation themes can be based on a user input requesting a specific subject matter (e.g., Jamaica vacations, golf trip to a preferred destination, etc.) or can be based on a public holiday, preferences of others within a social networking website, or based on channel guides (e.g., online TV channel guides, music channel guides, etc.).

The playlist of multimedia content is stored by the multimedia generator circuit as a data structure, for example at an identifiable location or via a prescribed service. Hence, a user can immediately enjoy a multimedia presentation based on execution of the playlist of multimedia content by the multimedia generator circuit (or a multimedia player) configured for retrieving the media content elements identified by their respective media identifiers, and playing or presenting the retrieved media content elements according to the respective presentation attributes specified within the playlist of multimedia content. Alternately, a second data structure (e.g., an “experience bookmark”) that references the playlist of multimedia content can be generated by the multimedia generator circuit, enabling large-scale distribution of the multimedia presentation throughout a wide area network based on the distribution of the experience bookmark to other users or other social networking sites via the wide area network.

Hence, the particular embodiments enable collections of media content elements of different media types to be dynamically assembled into a scalable multimedia presentation based on assembling the media identifiers of the respective media content elements into a playlist of multimedia content that can be executed by multimedia players, and distributing the experience bookmark that references the playlist of multimedia content.

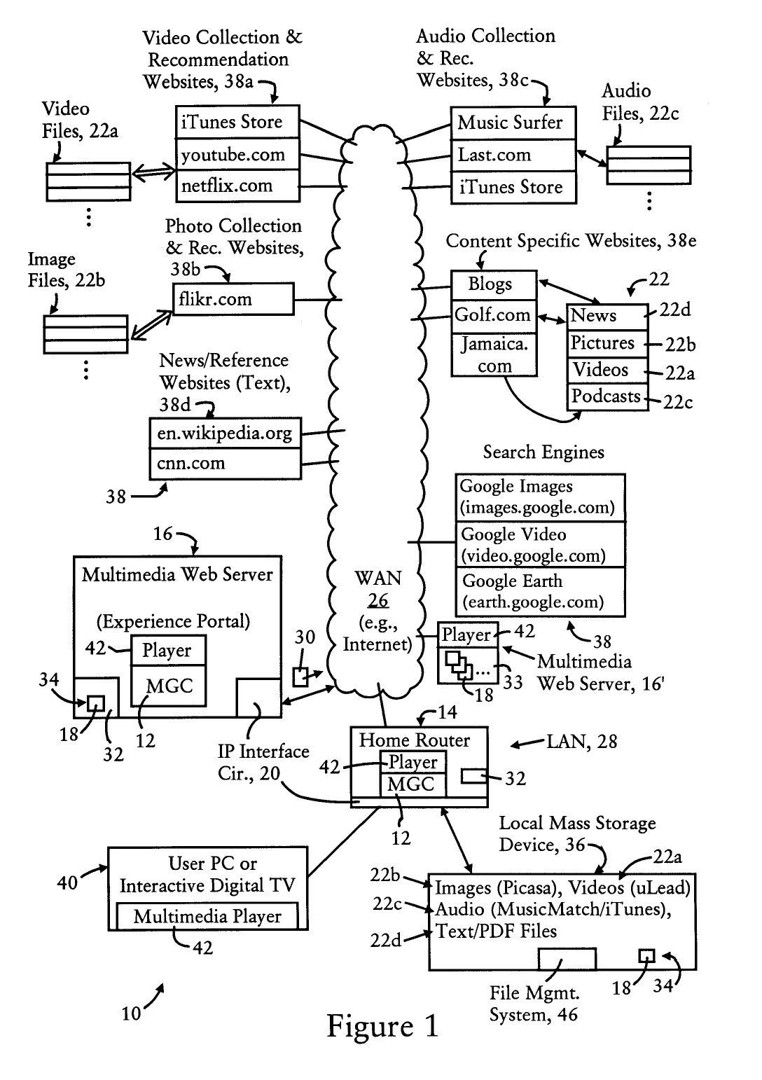

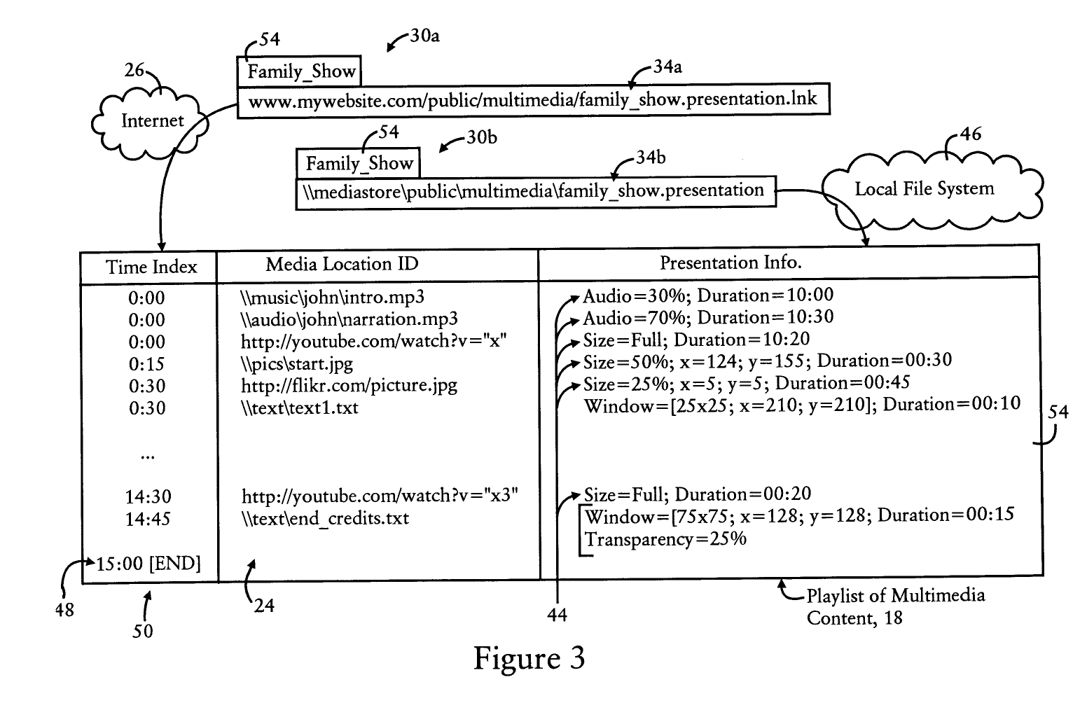

FIG. 1 illustrates an example system 10 enabling a multimedia generator circuit 12 within a network node (e.g., a customer premises router 14 or a web server 16) to automatically generate a playlist of multimedia content 18, according to an example embodiment. As illustrated in FIG. 1, the customer premises router (e.g., a commercially available Linksys® WRT54G wireless router modified as described herein) 14 and the web server 16 each can include an IP interface circuit 20, and the multimedia generator circuit (MGC) 12. Each IP interface circuit 20 can be configured for outputting requests to available media sources 36 or 38, via an IP-based network (e.g., the wide area network (WAN) 26 or a local area network 28), for information related to media content elements 22, described below. Each IP interface circuit 20 also can be configured for receiving media identifiers 24 (illustrated in FIG. 3) from the media sources 36 or 38 and that reference respective media content elements 22. For example, a media identifier 24 can be implemented as a location identifier that identifies a static storage address of a media content element 22 stored on a web server or a file store; another example of the media identifier 24 can be a reference to a prescribed service (e.g., a web service) configured for dynamically retrieving the media content element 22 on behalf of the requester. Each IP interface circuit 20 also can be configured for outputting onto an IP-based network (e.g., the wide area network (WAN) 26 or a local area network 28) a multimedia presentation (e.g., within a media stream) for delivery to a user device 40, based on execution of the playlist of multimedia content 18 by the corresponding MGC 12 or a corresponding multimedia player 42. As described below, each IP interface circuit 20 also can output onto any one of the IP-based networks 26 or 28 a playlist identifier (also referred to as an experience bookmark) 30 that references the playlist of multimedia content, for example based on identifying an identifiable destination 34 for reaching the playlist of multimedia content 18. The playlist identifier 30 can reference a specific stored location address for the playlist of multimedia content, or can reference a service (e.g., a web service executed on a web server) that can dynamically retrieve the playlist of multimedia content. Outputting the playlist identifier 30 onto the IP-based network 26 or 28 enables any multimedia player circuit 42 (e.g., in the server 16, in any other device connected to the WAN 26, in the home router 14, or in the user device 40) to create the multimedia presentation based on retrieving the playlist of multimedia content 18 using the reference 34 specified in the experience bookmark 30, retrieving the media content elements 22 identified by the respective media identifiers 24, and presenting the retrieved media content elements 22 according to the respective presentation attributes 44 specified for the media identifiers 24, illustrated in FIG. 3. The playlist identifier 30 also can be propagated throughout social networking websites.

As illustrated in FIG. 1, the router 14 and the server 16 also can include a memory circuit 32 that can be configured for storing the playlist of multimedia content 18 at an identifiable location, illustrated as a URL 34a or a pathname 34b in FIG. 3. Alternately, the storage of the playlist of multimedia content 18 can be distributed across a distributed system, for example via a web service provided by a multimedia web server 16′ that includes the player 42 and a service for dynamically retrieving stored playlists 18 from a local memory cache circuit (or local data server) 33 based on a playlist identifier referencing the appropriate service within the multimedia web server 16′. The memory circuit 32 also can be configured for storing executable code, or temporary data used by the multimedia generator circuit 12 during creation of the playlist of multimedia content 18, for example the media identifiers 24. As illustrated in FIG. 1 with respect to the MGC 12 in the router 14, the playlist of multimedia content 18 also can be stored in a local mass storage device 36 that is reachable via the local area network 28, for example a disc drive connected to a user device, or a networked disc drive.

Any of the disclosed circuits of the router 14 or the multimedia web server 16 (including the multimedia generator circuit 12, the IP network interface circuit 20, the memory circuit 32, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor such as a microprocessor circuit (not shown), where execution of executable code stored in an internal memory circuit (e.g., within the memory circuit 32) causes the processor circuit to store application state variables in processor memory, creating an executable application resource (e.g., an application instance) that performs the operations of the circuit as described herein. Hence, use of the term “circuit” in this specification refers to both a hardware-based circuit that includes logic for performing the described operations, or a software-based circuit that includes a reserved portion of processor memory for storage of application state data and application variables that are modified by execution of the executable code by a processor. The memory circuit 28 can be implemented, for example, using a non-volatile memory such as a programmable read only memory (PROM) or an EPROM, and/or a volatile memory such as a DRAM, etc.

Further, any reference to “outputting a message”, “outputting a packet” can be implemented based on creating the message/packet in the form of a data structure and storing that data structure in a tangible memory medium in the disclosed apparatus (e.g., in a transmit buffer). Any reference to “outputting a message” or “outputting a packet” also can include electrically transmitting (e.g., via wired electric current or wireless electric field, as appropriate) the message/packet stored in the tangible memory medium to another network node via a communications medium (e.g., a wired or wireless link, as appropriate) (optical transmission also can be used, as appropriate). Similarly, any reference to “receiving a message” or “receiving a packet” can be implemented based on the disclosed apparatus detecting the electrical (or optical) transmission of the message/packet on the communications medium, and storing the detected transmission as a data structure in a tangible memory medium in the disclosed apparatus (e.g., in a receive buffer).

Also note that the memory circuits 32 can be implemented dynamically by the multimedia generator circuit 12, for example based on memory address assignment and partitioning executed by the multimedia generator circuit 12.

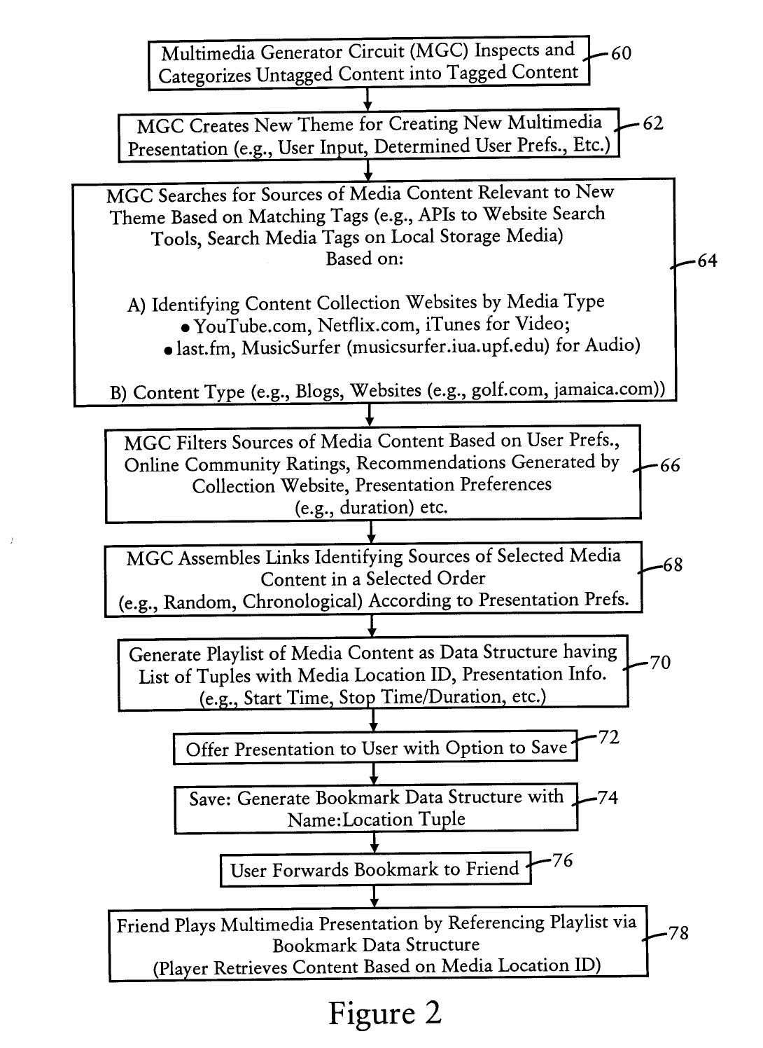

FIG. 2 illustrates an example method for automatically generating the playlist of multimedia content 18 and the playlist identifier 30 by the multimedia generator circuit 12, according to an example embodiment. The steps described in FIG. 2 can be implemented as executable code stored on a computer readable medium (e.g., floppy disk, hard disk, ROM, EEPROM, nonvolatile RAM, CD-ROM, etc.) that are completed based on execution of the code by a processor; the steps described herein also can be implemented as executable logic that is encoded in one or more tangible media for execution (e.g., programmable logic arrays or devices, field programmable gate arrays, programmable array logic, application specific integrated circuits, etc.).

Referring to FIG. 2, the multimedia generator circuit 12 can search and inspect locally-available media sources in step 60, for example the local mass storage device 36 that is locally reachable by the router 14 via the local area network 28. Alternately, the multimedia generator circuit 12 can rely on content indexing executed by another resource, for example a local search engine or another service that can index the locally-available content. The multimedia generator circuit 12 of the home router 14 can search and inspect the local mass storage device 36 to detect whether the locally-available media source 36 includes untagged media content elements. For example, the local mass storage device 36 can include media content elements 22 that can be tagged, for example in the form of metadata that is embedded within the file 22, metadata that is appended to the file 22, or metadata that is distinct from the file 22 but which includes a reference for locating the corresponding file 22. Such tags can be generated based on different media management systems, or a file management system 46 used to control storage of the media content elements 22 within the storage device 36. For example, video files 22a can be tagged by a video editor such as the commercially available “uLead Video Studio” executed on a user device 40; image files 22b can be tagged by an image management software resource such as the commercially available “Picasa” software; audio files (e.g., MP3 files) 22c can be tagged by audio cataloging software resources such as the commercially available “MusicMatch Jukebox” or the “iTunes” software; text files 22d can be tagged by word processing software or software configured for converting media formats, for example software that converts text files into a portable document format (PDF) as developed by Adobe Systems. Further, the file management system 46 can add its own metadata related to storage of the files within the mass storage device 36 according to a prescribed directory structure (e.g., NTFS or “New Technology File System”).

Hence, the MGC 12 can detect in step 60 whether any of the media content elements 22 stored locally within the mass storage device 36 are untagged media content elements (i.e., content elements that do not have any associated metadata that can be used by the MGC 12 for classifying media content elements relative to a prescribed multimedia presentation theme). The MGC 12 can categorize any untagged media content elements stored in the local mass storage device 36 based on assigning to each untagged media content element 22 a corresponding media tag that specifies a prescribed subject matter: the media tag can be assigned by the MGC 12 based on the MGC 12 parsing other metadata associated with the files 22, including the metadata generated by the file management system 46, and any metadata generated by the above-described software resources that either generated the media content elements 22, or managed editing or storage of the media content elements 22.

Regardless of whether a media content element 22 is stored either locally within a local storage device 36 or is reachable via a remote media source 38, the tagging of any media content element 22 enables the multimedia generator circuit 12 to determine whether that media content element 22 should be used for a given multimedia presentation having a prescribed multimedia presentation theme, described below. The tagging is not limited to a text tag for a theme, rather the tags can encompass all attributes that can be accessible, for example media presentation duration, media resolution, language, price or cost of ownership, license ownership or authorization attributes, Global Positioning System (GPS) coordinates, parental controls, cross-references to social recommendations, etc. As apparent from the foregoing, however, the multimedia generator circuit 12 can utilize existing tags having already been added by the respective media sources 38, for example based on cataloging software or social networking activities performed at the media sources 38. As described below, the multimedia generator circuit 12 also can rely on detected user community ratings having been established at a media source website 38, or recommendation values specified by the media sources (e.g., “last.fm”) 38.

The MGC 12 can create in step 62 a new multimedia presentation theme for creation of a new multimedia presentation, for example based on a user input supplied to the multimedia web server 16 by a user of the user device 40 via the wide area network 26. Alternatively, the MGC 12 can create the new multimedia presentation theme based on parsing a subscriber profile stored locally or remotely: for example, either the router 14 or the service 16 can periodically access a stored subscriber profile and in response periodically generate a playlist of multimedia content for a prescribed multimedia presentation theme. For example, if a subscriber profile indicates a user of the device 40 is interested in golf vacations and vacations to Jamaica, and that the user wishes to be updated once a week with new multimedia presentations, the MGC 12 in response can automatically initiate generation of a new playlist of multimedia content 18 for the prescribed multimedia presentation theme (e.g., golf vacations, Jamaica vacations) every week according to the subscriber profile.

The MGC 12 in the router 14 or the server 16 can initiate the automatic generation of the playlist of multimedia content 18 by searching in step 64 for the media content elements 22 among the available media sources 36 and/or 38 having attributes (e.g., tags) that match the prescribed multimedia presentation theme (e.g., golf vacations or Jamaica vacations). For example, the MGC 12 can send queries specifying the prescribed multimedia presentation theme to known content collection websites that collect media content elements 22 according to media type: example websites include video collection and recommendation websites (e.g., “iTunes Store”, “youtube.com”, “netflix.com”) 38a, photo collection and recommendation websites (e.g., “flikr.com”) 38b, audio collection and recommendation websites (e.g., Music Surfer at “musicsurfer.iua.upf edu”, “last.com” or “iTunes Store”) 38c, or text-based news or reference websites (e.g., “wikipedia.org” or “cnn.com”) 38d. As apparent from the foregoing, many of these collection and recommendation websites 38a, 38b, 38c, and 38d can utilize social networking that enables the respective media content elements 22a, 22b, 22c, and 22d to be assigned respective tags or metadata that describe the subject matter of the content, or the popularity (or reliability) of the content. As used herein, reliability can refer to the quality of the content based on numerous socially-relevant criteria, including age-appropriate classification, artistic or stylistic criteria, competitive ranking, etc.

The MGC 12 also can send a query specifying the prescribed multimedia presentation theme to content-based websites 38e that can include any one of the media content elements 22a, 22b, 22c, or and/or 22d for a specific subject matter (e.g., golf at “golf.com”, Jamaica vacations at “jamaica.com”), or which can include search engines for locating relevant content, for example search engines (e.g., “blogsearch.google.com”) for searching for web logs (“blogs”) relevant to a specific subject matter.

Note that the MGC 12 can be configured for sending the queries to the websites 38 using application programming interfaces (APIs) that are published by the websites 38 as available for use; hence, the MGC 12 can receive query results in a text-based format (e.g., an ASCII string) that can be easily parsed by the MGC 12. The query results can include media identifiers 24, illustrated in FIG. 3, that reference the media content elements 22 satisfying the query by the MGC 12 or the local search using the file management system 46. Example query results also can include a data structure in the form of a BitTorrent index: the BitTorrent index can includes a list of media content elements implemented as BitTorrent files, media identifiers enabling BitTorrent peers to download the respective BitTorrent files, and metadata describing the media content elements identified in the BitTorrent index.

The MGC 12 also can be configured for searching media tags on local storage media (e.g., the local mass storage device 36) in order to identify locally-storage media content elements 22 that are stored in the local device 36.

After the MGC 12 has identified in step 64 the media content elements 22 that are relevant to the prescribed multimedia presentation theme by their respective media identifiers 24, the MGC 12 can filter in step 66 the query results based on prescribed filtering parameters. Example filtering parameters include parental controls, user preferences such as language preference or media resolution (e.g., HDTV quality vs. low-bandwidth economical quality), the online user community ratings, the recommendation values generated by the collection websites 38, plus presentation preferences. Example presentation preferences include size restrictions including audio or video files having a prescribed limited length, (e.g., a media content element duration no longer than 10 minutes for a 15 minute multimedia presentation).

The MGC 12 assembles in step 68 the filtered results, namely the media identifiers 24 satisfying the filtering criteria of step 66, into the playlist of multimedia content 18 for the prescribed multimedia presentation theme. In particular, the MGC 12 assembles the media identifiers 24 according to a prescribed presentation preference (e.g., a 15 minute duration) 48, and a prescribed presentation sequence 50, illustrated in FIG. 3 as a time index that starts at a time index “0:00” and ends at 15 minutes “15:00”. Example presentation preferences include not only presentation duration, but preferred media mixing (e.g., adding image with audio), “mood”, preferred tempo, etc. The MGC 12 can then automatically generate in step 70 the playlist of multimedia content 18 as a list of tuples that specify a media identifier 24, and a corresponding set of presentation information attributes 44. In particular, the MGC 12 can add presentation attribute information 54 for use by the multimedia player 42 in rendering the media content elements 22 following retrieval thereof as referenced by their respective media identifiers 24. As illustrated in FIG. 3, each media identifier 24 includes a corresponding set of presentation attributes (e.g., relative audio mixing percentage, duration, display position, display size, text window position, text window transparency, etc.) 44 to enable precise rendering of the corresponding media content element 22 by any multimedia player 42.

The MGC 12 can offer in step 72, for example as part of a user interface session, an option to a user of the user device 40 for displaying the multimedia presentation based on execution of the playlist of multimedia content 18 generated in step 70. For example, execution of the playlist of multimedia content 18 illustrated in FIG. 3 by any player 42 begins at time index “0:00” 50 with the concurrent playing by the player 42 at respective durations of the audio file “intro.mp3” (at 30% audio mixing level), the audio file “narration.mp3” (at 70% mixing level), and the full screen playing of the video illustrated by the reference “youtube.com/watch?v=‘x’”. At time index “0:15” (i.e., fifteen seconds after the start) 50 the player 42 adds the display of the picture “startjpg” for the next thirty seconds at a first size (“Size=50%”) and location (x, y screen coordinates); at time index “0:30” (i.e., thirty seconds after the start) 50 the player 42 adds the display of the picture “picturejpg” for the next forty-five seconds at a corresponding size (“Size=25%”) and position (x, y screen coordinates), and the display of the text “text1.txt” for a duration of ten seconds. Hence, at time index “0:30” the player 42 concurrently presents the six aforementioned media content elements.

The MGC 12 also can save the experience bookmark data structure (e.g., 30a or 30b of FIG. 3) in step 74 by specifying a tuple that identifies an experience bookmark name 54 and a corresponding reference or identifier (e.g., 34a or 34b), for example a reference to a stored location, a reference to a service (e.g., executed by the multimedia web server 16′) for retrieving playlist of multimedia content or presenting the multimedia presentation, a hash value, etc. Generation of the experience bookmark data structure 30a enables the user to forward in step 76 the experience bookmark 30a to another user enabling the user to share the experience with other users, enabling worldwide distribution in step 78 of the multimedia presentation assuming that all the media identifiers 24 are globally reachable, or distribution of at least a portion of the multimedia presentation. Examples of a globally-reachable experience bookmark data structure 30a include a tuple of individual references, a unique hash of the tuple of individual references, a sequentially allocated index into a database, an assigned IPv6 address, etc. As illustrated in FIG. 3, the playlist of multimedia content 18 can include a combination of globally reachable identifiers (i.e., reachable via the wide area network 26) and locally reachable identifiers (i.e., reachable via the local file system 46. In this case, a local user within the local area network 28 can use either the global experience bookmark 30a or the local experience bookmark 30b. Note that remote users also can enjoy a multimedia presentation based on execution of the playlist of multimedia content 18, except that the locally reachable content will not be presented; a lack of locally reachable content, however, may not be of concern to remote users who are unaware of the locally reachable content, as the globally reachable content still may provide sufficient information or entertainment for the remote multimedia users. Further, it will become apparent that the use of locally-available media sources is optional, and that the MGC 12 can be configured to use all globally reachable identifiers 24 within the playlist of multimedia content 18, enabling worldwide distribution of the multimedia presentation in a scalable manner.

As apparent from the foregoing, the playlist of multimedia content 18 and its corresponding experience bookmark 30a also can be classified and rated on social networking websites, providing further value to the corresponding multimedia presentation. In addition, the MGC 12 can be configured for accessing previously-generated playlists 18 and generate new playlists of multimedia content based on modifying the previously-generated playlist 18 or appending new information 50, 24, 44 to the previously-generated playlist 18. In addition, different generations of a playlist 18 can be generated for more specific multimedia presentations, for example low-bandwidth presentations (e.g., 1.5 Mbps) or high-bandwidth (e.g., 100 Mbps or Gigabit) presentations, language-specific presentations, age-specific presentations, etc. Different playlists 18 also can be generated that present the same media content elements in the same way and at the same time, but based on different media identifiers. In other words, since availability of a given media content element can be distributed throughout a wide area network 26 as distinct copies of the same media content element, different media identifiers can reference the same media content element from respective destinations. Hence, different playlists 18 having different media identifiers can generate the same experience for a user, since the same media content elements can obtained from different destinations. In the same manner, distribution of the playlist of multimedia content 18 enables multiple distinct playlist identifier to reference distinct “copies” of the playlist of multimedia content 18.

In addition, the multiple playlists 18 and/or their respective experience bookmarks 30a or 30b can be aggregated at a prescribed location (e.g., a web site) reachable via the WAN 26, enabling the formation of an “experience channel” based upon a set of themes, resulting effectively in the formation of an “automatic Internet TV”.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
identifying, by a multimedia generator circuit, media content elements from at least one available media source based on a prescribed multimedia presentation theme, each media content element identified as accessible from the at least one available media source via a corresponding media identifier, the prescribed multimedia presentation theme having been obtained by the multimedia generator circuit for a multimedia user; and
automatically generating, by the multimedia generator circuit, a playlist of multimedia content according to the multimedia presentation theme based on assembling the media identifiers according to a prescribed presentation preference.

2. The method of claim 1, further comprising generating for the multimedia user, by the multimedia generator circuit, at least one of a multimedia presentation based on executing the playlist of multimedia content, or a playlist identifier that references for the multimedia user the playlist of multimedia content.

3. The method of claim 2, wherein the automatically generating includes storing the playlist of multimedia content as a data structure, the method further comprising generating by the multimedia generator circuit a second data structure that identifies the reference to the playlist of multimedia content for execution of the playlist of multimedia content by a multimedia player circuit, the reference in the second data structure specified as one of a universal resource identifier or a file path according to a prescribed file system.

4. The method of claim 1, further comprising searching, by the multimedia generator circuit, for at least a portion of the media content elements from locally-stored media content elements stored within a locally-available media source reachable via a local area network, the identifying including selecting at least a portion of the locally-stored media content elements having media tags determined by the multimedia generator circuit as specifying a subject matter relevant to the prescribed multimedia presentation theme.

5. The method of claim 4, further comprising:
detecting within the locally-available media source untagged media content elements by the multimedia generator circuit; and
assigning to each of the untagged media content elements a corresponding media tag that specifies a prescribed subject matter, based on detected attributes of the corresponding untagged media content element.

6. The method of claim 1, wherein the identifying includes:
sending a query specifying the prescribed multimedia presentation theme to the at least one available media source via a wide area network; and
receiving a query result from the at least one available media source that includes at least a portion of the identified media content elements.

7. The method of claim 6, wherein the identifying further includes filtering the query results based on at least one of a user preference, a detected user community rating, a recommendation value specified by the at least one available media source, or the prescribed presentation preference.

8. The method of claim 1, wherein the playlist of multimedia content includes the media identifiers arranged according to a prescribed presentation sequence, and presentation attribute information specifying presentation attributes for each corresponding media identifier.

9. The method of claim 1, wherein the playlist of multimedia content includes the media identifiers for distinct media types from distinct media sources, at least one of the media sources being reachable via a local area network and at least a second of the media sources being reachable via a wide area network.

10. The method of claim 1, wherein the prescribed multimedia presentation theme is received by the multimedia generator circuit based on at least one of:
a user input via a wide area network; or
retrieval of the prescribed multimedia presentation theme from prescribed preference information for the multimedia user.

11. An apparatus comprising:
a network interface configured for retrieving media identifiers from at least one available media source; and
a multimedia generator circuit configured for identifying media content elements from the at least one available media source based on a prescribed multimedia presentation theme, each media identifier referencing the corresponding media content element from the at least one available media source, the prescribed multimedia presentation theme having been obtained by the multimedia generator circuit for a multimedia user;
the multimedia generator circuit further configured for automatically generating a playlist of multimedia content according to the multimedia presentation theme based on assembling the media identifiers according to a prescribed presentation preference.

12. The apparatus of claim 11, wherein the multimedia generator circuit further is configured for generating for the multimedia user at least one of a multimedia presentation based on executing the playlist of multimedia content, or a playlist identifier that references for the multimedia user the playlist of multimedia content, the network interface configured for outputting the at least one of the multimedia presentation or the playlist identifier.

13. The apparatus of claim 12, wherein the multimedia generator circuit further is configured for storing the playlist of multimedia content as a data structure, and generating a second data structure that identifies the reference to the playlist of multimedia content for execution of the playlist of multimedia content by a multimedia player circuit, the reference in the second data structure specified as one of a universal resource identifier or a file path according to a prescribed file system.

14. The apparatus of claim 11, wherein the multimedia generator circuit further is configured for searching for at least a portion of the media content elements from locally-stored media content elements stored within a locally-available media source reachable via a local area network, wherein the multimedia generator circuit further is configured for selecting the portion of the media content elements from the locally-stored media content elements having media tags determined by the multimedia generator circuit as specifying a subject matter relevant to the prescribed multimedia presentation theme.

15. The apparatus of claim 14, wherein the multimedia generator circuit further is configured for:
detecting within the locally-available media source untagged media content elements; and
assigning to each of the untagged media content elements a corresponding media tag that specifies a prescribed subject matter, based on detected attributes of the corresponding untagged media content element.

16. The apparatus of claim 11, wherein the multimedia generator circuit further is configured for identifying the media content elements based on:
sending via the network interface circuit a query specifying the prescribed multimedia presentation theme to the at least one available media source via a wide area network; and
receiving via the network interface circuit a query result from the at least one available media source that includes at least a portion of the identified media content elements.

17. The apparatus of claim 16, wherein the multimedia generator circuit further is configured for identifying the media content elements based on filtering the query results based on at least one of a user preference, a detected user community rating, a recommendation value specified by the at least one available media source, or the prescribed presentation preference.

18. The apparatus of claim 11, wherein the playlist of multimedia content includes the media identifiers arranged by the multimedia generator circuit according to a prescribed presentation sequence, and presentation attribute information added by the multimedia generator circuit and specifying presentation attributes for each corresponding media identifier.

19. The apparatus of claim 11, wherein the playlist of multimedia content includes the media identifiers for distinct media types from distinct media sources, at least one of the media sources being reachable via a local area network and at least a second of the media sources being reachable via a wide area network.

20. The apparatus of claim 11, wherein the prescribed multimedia presentation theme is received by the multimedia generator circuit based on at least one of:
a user input received by the network interface circuit via a wide area network; or
retrieval of the prescribed multimedia presentation theme from prescribed preference information for the multimedia user.

21. An apparatus comprising:
means for retrieving media identifiers from at least one available media source; and
means for identifying media content elements from the at least one available media source based on a prescribed multimedia presentation theme, each media identifier referencing the corresponding media content element from the at least one available media source, the prescribed multimedia presentation theme having been obtained by the means for identifying for a multimedia user;
the means for identifying further configured for automatically generating a playlist of multimedia content according to the multimedia presentation theme based on assembling the media identifiers according to a prescribed presentation preference.
